(19) United States
(12) Patent Application Publication
(10) Pub. No.: US 2025/0374929 A1
(43) Pub. Date: Dec. 11, 2025

(54) BATTER, DEEP-FRIED FOOD PRODUCT, AND METHODS FOR PRODUCING THE SAME

(71) Applicant: NICHIREI FOODS INC., Tokyo (JP)

(72) Inventors: Takashi HATA, Nankoku-shi, Kochi (JP); Yusuke NISHIUCHI, Nankoku-shi, Kochi (JP); Kaori TADA, Nankoku-shi, Kochi (JP); Yuichi ISHIZAKI, Tokyo (JP); Kenta ARAI, Tokyo (JP); Yasuyuki TSUTSUI, Tokyo (JP); Hitoshi AOKI, Tokyo (JP); Shinya TSUKAMOTO, Tokyo (JP)

(73) Assignee: NICHIREI FOODS INC., Tokyo (JP)

(21) Appl. No.: 18/876,992

(22) PCT Filed: Jul. 7, 2023
(86) PCT No.: PCT/JP2023/025309

§ 371 Date: Dec. 19, 2024

(30) Foreign Application Priority Data
Jul. 8, 2022 (JP) 2022-110393

(51) Int. Cl. A21D 8/02; A21D 10/04; A23L 5/10; A23L 13/50

(52) U.S. Cl. CPC A21D 8/025; A21D 10/04; A23L 5/11; A23L 13/57

(57) ABSTRACT

The present disclosure provides a new technical means for imparting crunchy, crispy, and other textures to the batter coating of deep-fried food products, and for preventing deterioration of such textures. More specifically, the present disclosure provides a method for producing batter for a deep-fried food product, the method comprising: providing a batter raw material liquid; introducing fine bubbles into the batter raw material liquid to obtain batter for a deep-fried food product.

### CROSS-REFERENCE TO RELATED APPLICATION

The present patent application claims priority based on Japanese Patent Application No. 2022-110393 filed on Jul. 8, 2022, and the content in such a prior patent application is incorporated herein by reference in its entirety.

### TECHNICAL FIELD

The present disclosure relates to batter, a deep-fried food product, and methods for producing the same.

### BACKGROUND ART

For deep-fried food products such as deep-fried chicken and croquettes, a combination of juicy fillings such as meat and seafood and a crunchy texture of the batter coating is preferred as good quality. At supermarkets, convenience stores, and other places, such deep-fried food products are displayed at normal temperature or in refrigerated form after being deep-fried on the spot, packaged in for example containers for sale, or displayed in warmer cases for in-store sales, such as electric heaters, to keep them warm for sale. Deep-fried food products sold in the above form, etc., have a problem in that the batter coating becomes hard and difficult to bite through, and the crunchy texture of the batter coating decreases. For example, in the case of deep-fried food products that are displayed and sold while kept warm in warmer cases, depending on the warming time, they are often discarded normally after about 3 to 4 hours have passed after warming in the warmer, as their value as products may significantly decrease.

On the other hand, various investigations have been performed in the past to maintain the texture of deep-fried food products in a state that is easily accepted by consumers. For example, it is common practice to adjust the amount of moisture compounded in the batter within the range where the function of the batter can be ensured, because a large amount of flour in the batter raw materials causes a heavy texture, difficulty in biting through the batter coating, and a feeling of sticking to the teeth. However, since the moisture absorbed by insoluble components in the batter raw material components is difficult to be evaporated by deep-frying, which is performed when producing deep-fried food products, the crunchy texture of the batter coating may decrease. Accordingly, it is often difficult to achieve both crunchy and crispy textures of the batter coating of deep-fried food products by adjusting the amount of moisture contained in the batter.

Also, there have been investigations in the past to adjust the texture of the batter coating of deep-fried food products by changing the batter raw materials such as fats and oils, and starches. However, even if the type of wheat-derived starch or other factors are simply changed, for example, as the amount of gluten increases, the batter coating may become hard and difficult to bite through, resulting in a bread-like texture rather than the original texture of the batter coating of deep-fried food products. In addition, even if the type of starch in the batter raw materials is changed to reduce the amount of gluten, the chewiness and other properties of the batter coating of deep-fried food products may be impaired.

Meanwhile, some approaches have been reported in recent years to improve the texture of the batter coating of deep-fried food products other than changing the amount of moisture or the raw material compositional features in the batter. For example, Patent Literature 1 discloses a method for producing porous wheat flour food products characterized by using water in which micro-nano bubbles are generated as a raw material for the batter.

### CITATION LIST

### Patent Literature

Patent Literature 1: JP 2010-166874 A

### SUMMARY OF INVENTION

However, there is still a demand for an effective technical means for maintaining the texture of the batter coating of deep-fried food products crunchy and crispy well, immediately after deep-frying and during the storage period required for retailing.

The present disclosure authors have conducted diligent investigations and have recently found that the introduction of fine bubbles into pre-provided batter can impart crunchy, crispy, and other textures to the batter coating of deep-fried food products, and can effectively prevent deterioration of such textures. The present disclosure is based on such a finding.

Accordingly, the present disclosure provides a new technical means for imparting crunchy, crispy, and other textures to the batter coating of deep-fried food products, and for preventing deterioration of such textures.

According to one embodiment of the present disclosure, there are provided a method for producing batter for a deep-fried food product, the method comprising: providing a batter raw material liquid; and introducing fine bubbles into the batter raw material liquid to obtain batter for a deep-fried food product, and batter for a deep-fried food product obtained thereby.

According to another embodiment of the present disclosure, there are also provided a method for producing a processed food product for deep-frying, comprising attaching the above batter to the surface of a filling, and a processed food product for deep-frying obtained thereby.

According to another embodiment of the present disclosure, there are also provided a method for producing a deep-fried food product, comprising deep-frying the above processed food product for deep-frying, and a deep-fried food product obtained thereby.

According to the present disclosure, crunchy, crispy, and other textures can be imparted to the batter coating of deep-fried food products, and deterioration of such textures can be prevented.

### BRIEF DESCRIPTION OF DRAWINGS

FIG. 1 is a graph showing the proportion (%) of the sum of the areas of void portions of 0.3 mm² or more to the entire cross-sectional area of the batter coating in deep-fried food (top surface of Comparative Section 1, top and side surfaces of Comparative Section 1A, top and side surfaces of Test Section 1, and side surface of Test Section 4),

FIG. 2 is an X-ray CT image of a cross-section of the batter coating in deep-fried food (top surface of Comparative Section 1, top and side surfaces of Comparative Section 1A, top and side surfaces of Test Section 1, and top and side surfaces of Test Section 4).

### DESCRIPTION OF EMBODIMENTS

### <Method for Producing Batter for Deep-Fried Food Product/Batter for Deep-Fried Food Product>

According to one embodiment of the present disclosure, the method for producing batter for a deep-fried food product is characterized by comprising providing a batter raw material liquid, and introducing fine bubbles into the batter raw material liquid to obtain batter for a deep-fried food product. In one embodiment of the present disclosure, the batter raw material liquid is pre-prepared such that it can be used as batter as it is even without introducing fine bubbles. In particular, it is a surprising fact that the introduction of fine bubbles into the batter raw material liquid can impart crunchy, crispy, and other textures to the batter coating of deep-fried food products, and can prevent deterioration of such textures,

### (Providing Batter Raw Material Liquid)

In one embodiment of the present disclosure, provision of the batter raw material liquid may be carried out by purchasing known batter or may be carried out by mixing the raw material components as appropriate. Accordingly, according to one embodiment of the present disclosure, providing the batter raw material liquid comprises mixing the raw material components.

In one embodiment of the present disclosure, the raw material components of the batter raw material liquid comprise at least raw material flour selected from grain flours, starches, and combinations thereof, and water.

Examples of the grain flours used as the raw material flour of the batter include wheat flour (weak flour, medium-strength flour, and strong flour), rice flour, and corn flour, as well as cereal flours such as barnyard millet and foxtail millet.

Examples of the starches used as the raw material flour of the batter include starches obtained by refining various raw materials such as tapioca, corn, potato, sweet potato, rice, mung bean, wheat, etc., and processed starches (such as acetylated starch) obtained by chemically processing these starches as appropriate.

There is no particular limitation on the content of the above raw material flour in the batter raw material liquid, but from the viewpoint of effectively attaching the batter to the entire surface of the filling, it can be, for example, 30 to 70% by mass with respect to the entire mass of the batter raw material liquid, and preferably 35 to 65% by mass, more preferably 40 to 60% by mass, and still more preferably 45 to 55% by mass.

There is no particular limitation on the content of water in the batter raw material liquid, but from the viewpoint of achieving both flowability and attachment of the batter, it can be, for example, 30 to 70% by mass with respect to the entire mass of the batter raw material liquid, and preferably 35 to 65% by mass, more preferably 40 to 60% by mass, and still more preferably 45 to 55% by mass.

Also, in one embodiment of the present disclosure, the batter raw material liquid may further contain other raw material components such as an emulsifier and a thickener.

As the emulsifier used in the batter raw material liquid, any emulsifier may be used as long as it is for food products, and for example, any of natural emulsifiers such as lecithin, saponin, and sodium caseinate and synthetic emulsifiers such as glycerin fatty acid ester, sorbitan fatty acid ester, propylene glycol fatty acid ester, and sucrose fatty acid ester may be used.

In one embodiment of the present disclosure, there is no particular restriction on the content of the emulsifier in the batter raw material liquid, and it can be determined depending on the contents of the other raw material components and water, such that they are well emulsified. The content of the emulsifier in the batter raw material liquid can be, for example, 0.1 to 5% by mass with respect to the entire mass of the batter raw material liquid, and preferably 0.5 to 2% by mass, more preferably 0.5 to 1.5% by mass.

Examples of the thickener used in the batter raw material liquid include polysaccharide thickeners such as xanthan gum, pectin, and guar gum.

The content of the thickener in the batter raw material liquid can be, for example, 0.01 to 5% by mass with respect to the entire mass of the batter raw material liquid, and preferably 0.01 to 2% by mass, more preferably 0.01 to 1% by mass.

In one embodiment of the present disclosure, the batter raw material liquid can contain, in addition to the above raw material components, other raw material components normally used in batter to the extent that the effects of the present disclosure are not impaired. Examples of the other raw material components include an edible oil such as soybean oil, a seasoning such as common salt, sugar, and amino acid, a coloring matter such as β-carotene, a flavoring agent, an acidifier, a pH adjuster, an emulsifier, a saccharide, a dietary fiber, and an animal or vegetable protein material.

In one embodiment of the present disclosure, the viscosity of the batter raw material liquid is preferably pre-adjusted with reference to characteristic information of the batter coating of the deep-fried food product from the viewpoint of improving the texture of the deep-fried food product. Suitable examples of such characteristic information of the batter coating of the deep-fried food product include the texture (such as crunchy texture and crispy texture) of the batter coating of the deep-fried food product, and the proportion (%) of the sum of the areas of void portions (such as 0.3 mm² or more) to the entire area of a cross-section of the batter coating of the deep-fried food product photographed using an X-ray CT (computed tomography) scanner.

In one embodiment of the present disclosure, in the case where the characteristic information of the batter coating of the deep-fried food product is the texture (such as crunchy texture and crispy texture) of the batter coating of the deep-fried food product, adjustment of the viscosity range of the batter raw material liquid is carried out such that the evaluation score of either crunchy texture or crispy texture of the batter coating of the deep-fried food product is, for example, higher by 0.6 or more, preferably by 0.8 or more, compared to the evaluation score of the reference section, Evaluation of the texture of the batter coating can be carried out using the approach described in Test Example 1, which will be mentioned later.

Also, in one embodiment of the present disclosure, in the case where the characteristic information of the batter coating of the deep-fried food product is the proportion (%) of the sum of the areas of void portions (0.3 mm² or more) to the entire area of a cross-section of the batter coating of the deep-fried food product photographed using an X-ray CT scanner, adjustment of the viscosity range of the batter raw material liquid is carried out such that the proportion (%) of the sum of the areas of void portions (0.3 mm² or more) to the entire area of a cross-section of the batter coating photographed using an X-ray CT scanner is, for example, less than 5%, preferably 3% or less. The method for measuring void portions with respect to the entire cross-sectional area of the batter coating of the deep-fried food product can be carried out using the approach described in Test Example 3, which will be mentioned later.

According to one embodiment of the present disclosure, as for the viscosity of the above batter raw material liquid, from the viewpoint of efficiently sealing fine bubbles, for example, the viscosity at 10° C. can be 500 to 10,000 cps, and preferably 1,000 to 6,000 cps, more preferably 1,500 to 4,000 cps. Without being bound by theory, if the viscosity of the batter is set in the above-mentioned range, fine bubbles sealed are less likely to escape while maintaining the flowability of the batter, and the volume of fine bubbles sealed is also improved, which is thought to improve the texture improving effect.

The viscosity of the batter raw material liquid can be adjusted by, for example, changing the types and proportions of the raw material components as appropriate.

Also, according to one embodiment of the present disclosure, the viscosity of the batter raw material liquid can be measured using a C-type viscometer (for example, model number “CVR-20” manufactured by Tokimec, Inc.).

### (Introducing Fine Bubbles)

According to one embodiment of the present disclosure, introducing fine bubbles comprises introducing fine bubbles into the above batter raw material liquid to obtain batter for a deep-fried food product. According to the method of the present disclosure, especially by introducing fine bubbles into the batter raw material liquid, it is possible to remarkably improve the characteristics such as the texture of the batter coating of the deep-fried food product.

Here, “fine bubbles” are air bubbles with a diameter of less than 100 μm, and are standardized by the International Organization for Standardization (ISO 20480-1). Also, among them, visible clouded air bubbles with a particle diameter of more than 1 μm and 100 μm or less are called “microbubbles”, and invisible, colorless and transparent air bubbles with a particle diameter of 1 μm or less are called “ultrafine bubbles”. In the present disclosure, such air bubbles can be generated by any known generation method, such as swirling liquid flow type, pressurized dissolution type, and micropore type. In the present disclosure, for example, Foamest column type_FP-20-300 manufactured by NAC, K.K., ultrafineGaLF FZ1N-05S manufactured by IDEC Corporation, Nanofresher NF-WP0.4 manufactured by NANOX Co., Ltd., YJ nozzle YJ-21 manufactured by Enviro Vision Co, Ltd., UFB DUAL manufactured by TechnicalLight, Inc., and NGB-I1-15/M manufactured by Noritake Co., Ltd. can be used. In the case where these devices are used, the desired particle diameter and air bubble particle density can be achieved by adjusting the supplied gas pressure (gas flow rate), liquid pressure (liquid flow rate), pore diameter of the filter used, and other factors according to the bubble generating scheme of each device. For example, in the case of a generation device that involves the flow of liquid to generate bubbles, such as a swirling liquid flow device, the particle diameter and air bubble particle density of the bubbles can be adjusted mainly by adjusting the supplied gas pressure (gas flow rate) and liquid pressure (liquid flow rate). Also, in the case of a generation device that does not involve the flow of liquid to generate bubbles, such as a pore type generation device, the particle diameter and air bubble particle density can be adjusted by adjusting the pore diameter of the filter used, in addition to the supplied gas pressure (gas flow rate) and liquid pressure (liquid flow rate). Furthermore, the bubbles may be generated by combining devices of different bubble generating schemes as appropriate.

According to one embodiment of the present disclosure, the fine bubbles may be repeatedly introduced into the batter raw material liquid using a known fine bubble introduction device, such as a pore type generation device. According to one embodiment, the flow rate of the batter raw material liquid, gas flow rate, and number of the above repetitions when introducing the fine bubbles are not particularly limited, and although they may be determined by taking into consideration the desired texture of the deep-fried food product and other factors. The flow rate of the batter raw material liquid can be, for example, about 1 to 3 mL/min, the gas flow rate of the fine bubbles can be, for example, about 50 to 200 mL/min, and the introduction treatment can be repeated about 1 to 20 times.

In one embodiment of the present disclosure, there is no particular limitation on the gas contained in air bubbles of the fine bubbles, and it may be air.

In one embodiment of the present disclosure, air bubble particles of fine bubbles with a particle diameter of about 100 μm or less are introduced into the batter raw material liquid. Batter containing such minute air bubble particles can efficiently impart good crunchy and crispy textures to the batter coating of the deep-fried food product through an deep-frying. Examples of preferred more specific ranges of the particle diameter of air bubble particles introduced into the batter raw material liquid include 1 nm to 100 μm, 1 nm to 80 μm, 10 nm to 60 μm, or 20 nm to 50 μm.

In the present disclosure, the particle diameter of particles such as air bubbles introduced into the batter raw material liquid refers to the diameter of the particles. The diameter of particles refers to the value corresponding to the diameter of each particle when it is assumed to be a perfect sphere. The particle diameter of air bubble particles introduced into the batter raw material liquid can be adjusted as appropriate in a known fine bubble introduction device as mentioned above.

In one embodiment of the present disclosure, there is no particular limitation on the temperature during introducing fine bubbles, but it is, for example, 25° C. or lower, preferably 20° C. or lower, more preferably 15° C. or lower, and most preferably 0 to 10° C. Also, the above temperature can be measured by, for example, inserting a thermometer normally used in the art in a state where the batter raw material liquid or batter is stirred and the temperature of the liquid is approximately uniform.

According to one embodiment of the present disclosure, batter for a deep-fried food product can be provided by introducing fine bubbles into the above batter raw material liquid by the method as mentioned above.

### <Processed Food Product for Deep-Frying/Production Method>

According to one embodiment of the present disclosure, there is also provided a method for producing a processed food product for deep-frying, comprising attaching the batter for a deep-fried food product obtained by the above method to the surface of a filling. Here, the “processed food product for deep-frying” refers to a food product that has been processed for a deep-frying treatment and has not been subjected to the deep-frying treatment yet.

The filling is not particularly limited, but it may be, for example, meat, seafood, or others. Depending on the type of deep-fried food product, the filling can be cut to a predetermined size and prepared in a predetermined manner, or used as it is.

Examples of the meat may comprise chicken, pork, beef, and other livestock meats. Examples of the seafood comprise shrimp and other crustaceans.

It is preferable to provide a water retaining agent solution that has a water retaining action of introducing moisture into the filling. The water retaining agent solution may contain, for example, one or a mixture of two or more of phosphates such as sodium polyphosphate, citrates such as trisodium citrate, and carbonates such as sodium carbonate, as well as salt and water. Also, seasonings that contain salt, such as soy sauce, can be used as the salt.

In the case where meat is used as the filling, it is preferable to provide a mixer with a container used for the water retention treatment. There is no particular limitation on the mixer with a container, as long as it is capable of mixing the above water retaining agent solution and a plurality of cut meats, and of allowing the water retaining agent solution to penetrate the surface of the meats, and examples thereof comprise a mixer equipped with a rotating cylindrical tank (tumbler) with a blade, which can be a commercial product.

Also, although there is no particular limitation on the method for attaching the batter to the surface of the filling, from the viewpoint of uniformly attaching the batter to the surface of the filling, it is preferable to use, for example, a treatment such as application or coating, or a treatment in which the batter and the filling are mixed.

There is no particular limitation on the amount of the batter to be attached to the filling, but from the viewpoint of covering the entire surface of the filling, it is normally set to about 5 to 30 parts by mass per 100 parts by mass of the filling.

According to one embodiment, before carrying out attaching to the filling, dusting flour can also be pre-applied to the filling according to a normal method.

Also, according to one embodiment, after attaching the above batter, in addition to the batter for batter coating of the present disclosure, another batter, batter coating material such as breader mix flour or bread crumbs, may be attached. Commercial products (such as breader mix flour) may be used as such a batter coating material.

According to one embodiment of the present disclosure, there is also provided a processed food product for deep-frying obtained by attaching the batter for a deep-fried food product to the surface of a filling. According to a preferred embodiment, the processed food product for deep-frying comprises a filling of the target deep-fried food product and a layer of the batter of the present disclosure, positioned on the outer side of the filling. The processed food product for deep-frying may be stored and sold as it is, or it may be stored and sold as a deep-fried food product by deep-frying.

### <Deep-Fried Food Product/Production Method>

According to one embodiment of the present disclosure, there is also provided a method for producing a deep-fried food product, comprising deep-frying the above processed food product for deep-frying. Here, the “deep-fried food product” refers to a food product obtained by deep-frying the processed food product for deep-frying, and is also referred to as “fried food”.

According to one embodiment of the present disclosure, deep-frying can be carried out using a known fryer. For the deep-frying conditions, the temperature and time can be set as appropriate by those skilled in the art, depending on the type, size, and other factors of the filling. For example, the oil temperature in the deep-frying is normally about 160 to 200° C., and the deep-frying time can be about 15 to 30 minutes.

Also, the deep-fried food product may be served as it is as a food product, but it may be stored at normal temperature for a certain period of time before being sold, or it may be subjected to a refrigeration or freezing treatment for storage and transport, and then sold to a wide range of consumers. Accordingly, according to one embodiment of the present disclosure, the method for producing the above deep-fried food product further comprises storing the deep-fried food product at normal temperature, freezing or refrigerating it. Such a treatment of storage at normal temperature, refrigeration, or freezing can be carried out by a known method. Here, the temperature applied to normal temperature, refrigeration, and freezing storage can be the same as for normal temperature sales, refrigeration sales, and refrigeration sales, which will be mentioned later.

Also, according to one embodiment of the present disclosure, the deep-fried food product that has been stored at normal temperature, refrigerated, or frozen may be served to consumers after being subjected to a deep-frying treatment again. Accordingly, according to one embodiment of the present disclosure, the method of the present disclosure comprises deep-frying the deep-fried food product obtained by storage at normal temperature, refrigeration, or freezing. Such second deep-frying can be carried out according to a known method similar to that of the first deep-frying.

According to another embodiment of the present disclosure, there is also provided a method for producing a deep-fried food product, comprising: providing the above batter for a deep-fried food product and a filling; attaching the above batter for a deep-fried food product to the surface of the filling to obtain a processed food product for deep-frying; deep-frying the processed food product for deep-frying to obtain a deep-fried food product; and, if desired, refrigerating or freezing the deep-fried food product. According to one embodiment of the present disclosure, there is also provided a deep-fried food product obtained by the above method.

Also, in one embodiment of the present disclosure, it is preferable to reduce the proportion of void portions with a large size in the batter coating of the deep-fried food product from the viewpoint of improving crunchy and crispy textures. According to one embodiment of the present disclosure, there is provided a deep-fried food product, wherein the proportion (%) of the sum of the areas of void portions (0.3 mm² or more) to the entire area of a cross-section of the batter coating photographed using an X-ray CT scanner is less than 5%. The proportion (%) of the sum of the areas of void portions (0.3 mm² or more) to the entire area of a cross-section of the batter coating of the deep-fried food product photographed using an X-ray CT scanner may be less than 5%, as mentioned above, but it is preferably 3% or less, more preferably 1% or less, still more preferably 0.5% or less, and even more preferably 0.1% or less.

Suitable examples of the deep-fried food product comprise croquettes, menchi katsu (fried cakes of minced meat), pork cutlets, fried shrimp, fried seafood, fried spring rolls, and other fried foods, tempura (such as kakiage), and deep-fried foods, although deep-fried foods are particularly preferred.

Since the deep-fried food product is excellent in storability, it can be advantageously used in supermarkets, convenience stores, and other places where it can be stored for a certain period of time and then sold. Accordingly, according to one embodiment of the present disclosure, the deep-fried food product can be used for warmer storage, where it is stored in a warmer case for about 10 minutes to 4 hours and sold, and for normal temperature, freezing, or refrigeration sales. Here, normal temperature sales mean that the deep-fried food product is normally sold in an environment of about 18 to 25° C. Also, refrigeration sales mean that the deep-fried food product is normally sold in an environment of about −5° C. to 10° C. Also, freezing sales mean that the deep-fried food product is normally sold in an environment of −18° C. or lower. Consumers who purchase such a deep-fried food product for normal temperature or refrigeration sales can eat the deep-fried food product as it is, or they can heat it up in a microwave oven or the like and eat it.

Also, according to one embodiment of the present disclosure, the following is provided.
(1) A method for producing batter for a deep-fried food product, the method comprising:
   providing a batter raw material liquid; and
   introducing fine bubbles into the batter raw material liquid to obtain batter for a deep-fried food product.
(2) The method according to (1), wherein a viscosity of the batter raw material liquid is adjusted to a range preset with reference to characteristic information of a batter coating of the deep-fried food product.
(3) The method according to (1) or (2), wherein the batter raw material liquid has a viscosity of 500 to 10,000 cps.
(4) The method according to any of (1) to (3), wherein a proportion (%) of a sum of areas of void portions of 0.3 mm² or more to an entire area of a cross-section of a batter coating of the deep-fried food product photographed using an X-ray CT scanner is less than 5%.
(5) The method according to any of (1) to (4), wherein the batter raw material liquid comprises at least grain flour and water.
(6) The method according to (5), wherein the batter raw material liquid further comprises at least one raw material component selected from an emulsifier and a thickener.
(7) Batter for a deep-fried food product obtained by the production method according to any of (1) to (6).
(8) A method for producing a processed food product for deep-frying, comprising attaching the batter according to (7) to a surface of a filling.
(9) A processed food product for deep-frying, comprising a filling and the batter for a deep-fried food product according to (7) attached to a surface of the filling.
(10) A method for producing a deep-fried food product, comprising deep-frying the processed food product for deep-frying according to (9).
(11) A deep-fried food product obtained by the production method according to (10).
(12) A deep-fried food product, wherein a proportion (%) of a sum of areas of void portions of 0.3 mm² or more to an entire area of a cross-section of a batter coating photographed using an X-ray CT scanner is less than 5%.

### EXAMPLES

Hereinafter, the present disclosure will be described with reference to Examples, but the present disclosure is not limited to these Examples. Note that, unless otherwise stated, the raw materials, units, measurement methods, and other specifications described herein are in accordance with the description in the Japanese Industrial Standards (JIS) and the Japanese Agricultural Standards (JAS).

### Test Example 1

(1) Production of Batter Raw Material Liquid Samples According to the recipe shown in Table 1 below, the raw material components were placed in a hand blender (manufactured by Braun GmbH, model number: MQ500) and mixed for about 4 minutes to obtain batter raw material liquid samples 1 to 6 (hereinafter, also referred to simply as “samples 1 to 6”) with a viscosity of 4000 cps. The viscosity of the batter raw material liquids was measured at 10° C. using a C-type viscometer (model number “CVR-20” manufactured by Tokimec, Inc.).

TABLE 1

| Raw material component | | Amount compounded (%) | | | | | |
|---|---|---|---|---|---|---|---|
| Common name | Manufacturer | Sample 1 | Sample 2 | Sample 3 | Sample 4 | Sample 5 | Sample 6 |
| Water | — | 54.4 | 54.4 | 53.9 | 53.9 | 54.4 | 54.4 |
| Polyglycerin fatty | Riken Vitamin Co., Ltd. | — | — | 1.0 | — | — | — |
| acid ester | | | | | | | |
| Sucrose fatty | Mitsubishi Chemical | — | — | — | 1.0 | — | — |
| acid ester | Corporation | | | | | | |
| Common salt | — | 1.0 | 1.0 | 1.0 | 1.0 | 1.0 | 1.0 |
| Weak flour | Nisshin Flour Milling Inc. | — | — | — | — | 44.5 | 22.3 |
| Wheat starch | Sanwa Starch Co., Ltd. | 44.5 | 22.3 | 22.0 | 22.0 | — | 22.3 |
| Acetylated starch | Matsutani Chemical | — | 22.3 | 22.0 | 22.0 | — | — |
| | Industry Co., Ltd. | | | | | | |
| Xanthan gum | San-Ei Gen F.F.I., Inc. | 0.07 | 0.07 | 0.07 | 0.07 | 0.07 | 0.07 |
| Guar gum | San-Ei Gen F.F.I., Inc. | 0.07 | 0.07 | 0.07 | 0.07 | 0.07 | 0.07 |

| | | | | | | |
|---|---|---|---|---|---|---|
| Total | 100 | 100 | 100 | 100 | 100 | 100 |

### (2) Test Sections 1 to 6

The batter raw material liquid samples 1 to 6 obtained in (1) were passed through a fine bubble pore type generation device (Noritake Co., Ltd., NGB-11-15/M) ten times at a rate of 2 L/min while air was added at a flow rate of 100 mL/min to introduce fine bubbles in conformity with ISO 20480-1, obtaining batter samples for deep-frying (hereinafter, also referred to as “fine bubble batters”), each of which was used in the following experiments as batter raw material liquid samples for Test Sections 1 to 6.

### (3) Comparative Sections 1 to 6

The batter raw material liquid samples 1 to 6 obtained in (1) were used as they were in the following experiments as the batter raw material liquid samples for Comparative Sections 1 to 6.

### (4) Production of Deep-Fried Chicken Using Batter Raw Material Liquid Samples

Using the batter raw material liquid samples obtained in (2) and (3), deep-fried chicken was produced according to the following procedures.
1. A raw material, raw chicken meat, was cut such that each piece had a mass of 25±2 g.
2. A seasoning liquid (20% of soy sauce, 3.3% of common salt, 3.3% of sodium glutamate, and 73.3% by mass of water) was weighed to 15 g per 100 g of the raw material raw meat, and put into a PE bag together with the meat.
3. The opening of the PE bag was sealed.
4. The meat in the PE bag was massaged at 12 rpm for 30 minutes in the chilled temperature range under normal pressure using a tumbler (vacuum massage tumbler MG-40 model).
5. The meat after tumbling was placed in a bowl, 3.0 g of processed starch (product name: Matsutani Bara, manufactured by Matsutani Chemical Industry Co., Ltd.) was added as dusting flour per 100 g of the raw material raw meat, and they were mixed.
6. Furthermore, 20.2 g of the batter raw material liquid sample was added to the bowl per 100 g of the raw material raw meat, and they were mixed.
7. The resulting meat with batter coating was deep-fried by deep-frying twice. Specifically, deep-frying was performed at 170° C. for 2 minutes, followed by resting at normal temperature for 2 minutes, and then deep-frying at 170° C. for 2 minutes,
8. The resulting deep-fried chicken was frozen in a freezer at about −35° C.

### (5) Preparation of Deep-Fried Chicken for Tasting

The frozen deep-fried chicken obtained in (2) above was deep-fried at 175° C. for 7 minutes.

Four pieces of deep-fried chicken immediately after deep-frying and four pieces of deep-fried chicken that had been stored in a warming appliance (ambient temperature set to 70° C.) for 3 hours after deep-frying were subjected to sensory evaluation.

### (6) Sensory Evaluation

The deep-fried chicken samples produced in (5) above were subjected to sensory evaluation by five expert panel members. The evaluation items and evaluation criteria were as described below, and the score of each sample was evaluated by setting each evaluation item of Comparative Section 1, to which no fine bubbles were added, to a score of 3 (the reference section). Four pieces of deep-fried chicken that had been stored for 3 hours were subjected to sensory evaluation.

### Crunchy Texture of Batter Coating (Score)

5: The entire batter coating is crunchy.
4: More crunchy portions of the batter coating compared to the reference section.
3: Reference section.
2: Less crunchy portions of the batter coating compared to the reference section.
1: The entire batter coating is not crunchy.

### Crispy Texture (Ease of Biting Through) (Score)

5: There is absolutely no difficulty in biting through the batter coating or feeling of sticking to the teeth.
4: The batter coating is difficult to bite through and there is a feeling of sticking to the teeth, but compared to the reference section, there are almost no problems as a whole.
3: Reference section.
2: Compared to the reference section, the batter coating is more difficult to bite through and there is a stronger feeling of sticking to the teeth.
1: The batter coating is very difficult to bite through and there is a strong feeling of sticking to the teeth, making it impossible to bite through.

### (6) Results

The results of sensory evaluation for each sample immediately after deep-frying are shown in Table 2 and Table 3 below. In Table 2 and Table 3, each of the evaluation items for Comparative Section 1 immediately after deep-frying is given a score of 3.

TABLE 2
Immediately after deep-frying

| | Crunchy texture of | Crispy texture of |
|---|---|---|
| Subject to be tested | batter coating | batter coating |
| Test Section 1 | 3.8 | 3.7 |
| Test Section 2 | 4.6 | 3.8 |
| Test Section 3 | 4.4 | 3.4 |
| Test Section 4 | 4.6 | 4.0 |
| Test Section 5 | 4.8 | 4.2 |
| Test Section 6 | 4.6 | 4.8 |

TABLE 3
Immediately after deep-frying

| | Crunchy texture of | Crispy texture of |
|---|---|---|
| Subject to be tested | batter coating | batter coating |
| Comparative Section 1 | 3.0 | 3.0 |
| Comparative Section 2 | 4.0 | 2.6 |
| Comparative Section 3 | 4.2 | 1.8 |
| Comparative Section 4 | 4.4 | 2.4 |
| Comparative Section 5 | 4.4 | 2.4 |
| Comparative Section 6 | 3.6 | 4.2 |

Also, the results of sensory evaluation for each sample stored for 3 hours after deep-frying are shown in Table 4 and Table 5 below. In Table 4 and Table 5, each of the evaluation items for Comparative Section 1 after 3 hours of storage is given a score of 3.

TABLE 4
After 3 hours of storage

| | Crunchy texture of | Crispy texture of |
|---|---|---|
| Subject to be tested | batter coating | batter coating |
| Test Section 1 | 3.8 | 3.7 |
| Test Section 2 | 3.7 | 3.2 |
| Test Section 3 | 3.8 | 3.0 |
| Test Section 4 | 4.0 | 3.0 |
| Test Section 5 | 4.0 | 4.0 |
| Test Section 6 | 3.8 | 4.0 |

TABLE 5
After 3 hours of storage

| | Crunchy texture of | Crispy texture of |
|---|---|---|
| Subject to be tested | batter coating | batter coating |
| Comparative Section 1 | 3.0 | 3.0 |
| Comparative Section 2 | 3.0 | 2.3 |
| Comparative Section 3 | 3.8 | 1.7 |
| Comparative Section 4 | 3.8 | 2.2 |
| Comparative Section 5 | 3.0 | 3.5 |
| Comparative Section 6 | 3.0 | 3.0 |

Comparing the corresponding Test Sections and Comparative Sections, it was confirmed that Test Sections in which fine bubbles were added to the pre-provided batter raw material liquid samples tended to exhibit higher scores for the texture (crunchy texture) and crispy texture of the batter coating compared to Comparative Sections in which no fine bubbles were added to the batter raw material liquid samples.

### Test Example 2

### (1) Production of Comparative Section 1A

Water was passed through a fine bubble generator (Noritake Co., Ltd., NGB-11-15/M) ten times at a rate of 2 L/min while air was added at a flow rate of 100 mL/min, and water containing fine bubbles with a particle diameter of 10 nm to 100 μm at 1.0×10³ particles/mL or more (hereinafter, also referred to as “FB water”) was obtained. Next, a batter raw material liquid sample was produced in the same manner as in Comparative Section 1 of Test Example 1, except that the FB water was used instead of water.

### (2) Preparation/Sensory Evaluation of Deep-Fried Chicken for Tasting

Using the batter raw material liquid samples of Test Section 1 and Comparative Section 1 of Test Example 1, as well as Comparative Section 1A, deep-fried food was prepared in the same manner as in Test Example 1, and sensory evaluation was performed.

### (3) Results

The results of sensory evaluation for each sample are shown in Table 6 and Table 7 below.

In Table 6, each of the evaluation items for Comparative Section 1 immediately after deep-frying is given a score of 3.

TABLE 6
Immediately after deep-frying

| | Crunchy texture of | Crispy texture of |
|---|---|---|
| Subject to be tested | batter coating | batter coating |
| Test Section 1 | 3.8 | 3.7 |
| Comparative Section 1 | 3.0 | 3.0 |
| Comparative Section 1A | 3.3 | 3.3 |

In Table 7, each of the evaluation items for Comparative Section 1 after 3 hours of storage is given a score of 3.

TABLE 7
After 3 hours of storage

| | Crunchy texture of | Crispy texture of |
|---|---|---|
| Subject to be tested | batter coating | batter coating |
| Test Section 1 | 3.8 | 3.7 |
| Comparative Section 1 | 3.0 | 3.0 |
| Comparative Section 1A | 3.3 | 3.2 |

Both immediately after oil coating and after 3 hours of storage, Test Section 1 (the batter sample produced by directly introducing fine bubbles into Comparative Section 1 was used) exhibited higher sensory evaluation scores compared to Comparative Example 1 (the batter sample produced without adding fine bubbles was used) and Comparative Section 1A (the batter sample produced using the FB water as a raw material was used) in terms of both the texture (crunchy texture) and crispy texture of the batter coating.

In Test Section 1, the inclusion of fine bubbles is thought to have made the structure of the batter coating sparse, improving the collapsibility of the batter coating and imparting a crunchy texture to the batter coating. Also, in general, the starch in the batter coating becomes filmy as time passes, causing difficulty in biting through, but in Test Section 1, the fine bubbles finely divided the starch film, which is thought to have prevented the occurrence of difficulty in biting through.

Also, the reason why Test Section 1 in which fine bubbles were directly introduced into the batter sample exhibited better scores compared to Comparative Example 1A in which the FB water was used is thought to be partly due to the fact that the viscosity of the batter made it more difficult for air bubbles to escape and the volume of fine bubbles introduced was larger.

Note that, in Comparative Example 1A in which the FB water was used, when the volume of the FB water in the batter was set to 50% or more, the batter raw material liquid lost viscosity and could not constitute batter, and it was found that there was an upper limit to the amount of the FB water used as a production raw material for the batter.

Also, when the viscosity range of the batter raw material liquids was adjusted and its influence on the quality of batter coating (crunchy texture and crispy texture) was checked according to the approaches of Test Example 1 and Test Example 2, it was confirmed that the quality was improved when the viscosity of the batter raw material liquid was in the range of 500 to 10,000 cps compared to Comparative Sections.

### Test Example 3

Using the batter raw material liquid samples of Test Section 1, Test Section 4, and Comparative Section 1 of Test Example 1, as well as Comparative Section 1A of Test Example 2, deep-fried food was prepared in the same manner as in Test Example 1. Next, the proportion of the area of voids of 0.3 m² or more to a cross-section of the batter coating of deep-fried food was calculated using X-ray CT photography, according to the following procedures,

### <Equipment Used>

Photographing equipment: Rigaku Corporation 3D micro X-ray CT scanner “CT Lab HX100”
Control software: Control software ver. 4.3.1.6122
Reconstruction software: CT reconstruction ver 1.1.1.0
Display and analysis software: VGSTUDIO MAX ver. 3.4.5

### <Procedures>

1. The deep-fried food was cut in half from the center.
2, The cut deep-fried food was placed on the sample rod with a diameter of 25 mm, with the flat cut surface facing down. The standard stage was used as the sample stage.
3. The position of the batter coating portion of deep-fried food was adjusted such that it was in the photographing field of view, and photographs were taken from each of the top surface and side surface sides, in accordance with the following photographing conditions.

### (Photographing Conditions)

Tube voltage: 100 kV
Tube current: 200 μA
Photographing time: 17 min
Photographing mode: High Resolution (Binning 1)
X-ray filter: None
Geometry: Long
FOV: 25×16.8 mm (magnification: 5.45, pixel size: 8.97 μm)

### (Device Conditioning)

Gain calibration at a tube voltage of 100 kV and a tube current of 200 μA
   CT Value Calibration with Air and Water
4. The photographed data was read by the analysis software, and thicker spots in the batter coating portion were selected and cut out such that the entire photographed cross-section was the batter coating portion.
5. Considering the batter coating portion in the cross-sectional image as “material” and void portions inside the batter coating (the regions surrounded by the outline (boundary line) of the voids) as “defects”, the material area and the area of each defect in the cross-section were calculated.
6. Defects of 0.3 mm² or more in the photographed cross-section were further extracted, and the sum of their areas was determined.
7. The “proportion of the sum of void portions of 0.3 mm² or more to the entire cross-sectional area of the batter coating” was calculated as (sum of defect areas of 0.3 mm² or more/material area)×100.

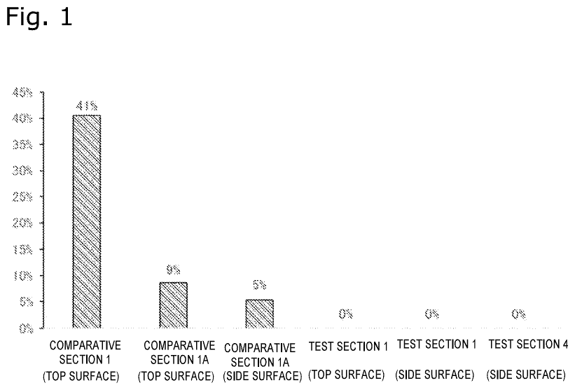

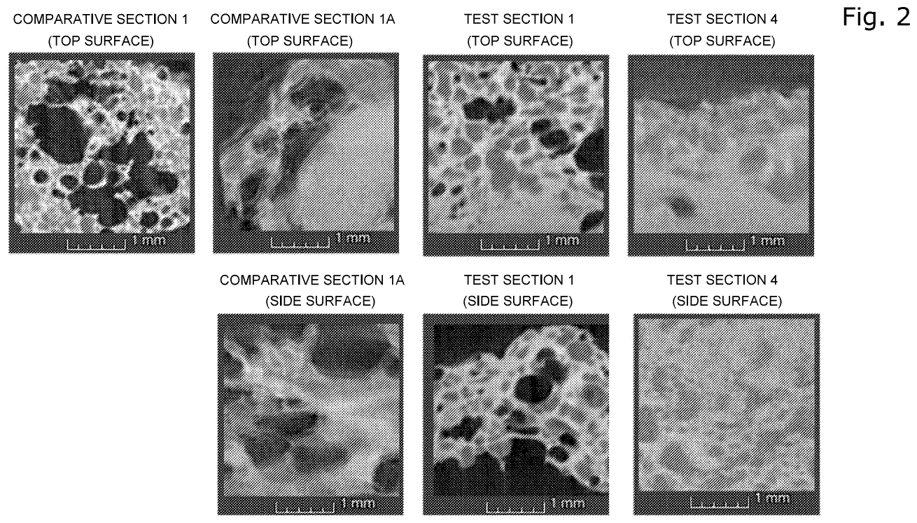

The results were as shown in FIG. 1 and FIG. 2.

FIG. 1 shows the proportion (%) of the sum of the areas of void portions of 0.3 mm² or more to the entire cross-sectional area of the batter coating of deep-fried food in the top surface of Comparative Section 1, top and side surfaces of Comparative Section 1A, top and side surfaces of Test Section 1, and side surface of Test Section 4.

Also, FIG. 2 shows an X-ray CT Image of a cross-section of the batter coating of deep-fried food in the top surface of Comparative Section 1, top and side surfaces of Comparative Section 1A, top and side surfaces of Test Section 1, and top and side surfaces of Test Section 4.

As shown in FIG. 1, the proportion was 0% in both Test Section 1 and Test Section 4, whereas it was 5% or more in Comparative Section 1 and Comparative Section 1A. It is thought that fine bubbles were retained in the batter liquid at a high level in Test Section 1 and Test Section 4, resulting in a smaller proportion of void portions of 0.3 mm² or more in the batter coating, which imparted crunchy, crispy, and other textures to the batter coating of deep-fried food.

According to the present disclosure, crunchy, crispy, and other textures can be imparted to the batter coating of deep-fried food products, and deterioration of such textures can be prevented.

1. A method for producing batter for a deep-fried food product, the method comprising:
providing a batter raw material liquid; and
introducing fine bubbles into the batter raw material liquid to obtain batter for a deep-fried food product.

2. The method according to claim 1, wherein a viscosity of the batter raw material liquid is adjusted to a range preset with reference to characteristic information of a batter coating of the deep-fried food product.

3. The method according to claim 1, wherein the batter raw material liquid has a viscosity of 500 to 10,000 cps.

4. The method according to claim 1, wherein a proportion (%) of a sum of areas of void portions of 0.3 mm² or more to an entire area of a cross-section of a batter coating of the deep-fried food product photographed using an X-ray CT scanner is less than 5%.

5. The method according to claim 1, wherein the batter raw material liquid comprises at least grain flour and water.

6. The method according to claim 5, wherein the batter raw material liquid further comprises at least one raw material component selected from an emulsifier and a thickener.

7. Batter for a deep-fried food product obtained by the production method according to claim 1.

8. A method for producing a processed food product for deep-frying, the method comprising attaching the batter according to claim 6 to a surface of a filling.

9. A processed food product for deep-frying, comprising a filling and the batter for a deep-fried food product according to claim 6 attached to a surface of the filling.

10. A method for producing a deep-fried food product, comprising deep-frying the processed food product for deep-frying according to claim 8.

11. A deep-fried food product obtained by the production method according to claim 9.

12. A deep-fried food product, wherein a proportion (%) of a sum of areas of void portions of 0.3 mm² or more to an entire area of a cross-section of a batter coating photographed using an X-ray CT scanner is less than 5%.
